(19) United States
(12) Patent Application Publication
(10) Pub. No.: US 2026/0239159 A1
(43) Pub. Date: Aug. 13, 2026

(54) DEVICES AND METHODS OF COMMUNICATION

(71) Applicant: LENOVO (BEIJING) LIMITED, Beijing (CN)

(72) Inventors: Lianhai Wu, Beijing (CN); Ran Yue, Beijing (CN); Jing Han, Beijing (CN); Haiming Wang, Beijing (CN); Min Xu, Beijing (CN); Jie Hu, Beijing (CN)

(21) Appl. No.: 19/471,007

(22) PCT Filed: Mar. 30, 2023
(86) PCT No.: PCT/CN2023/085217

§ 371 Date: Sep. 30, 2025

(51) Int. Cl. H04W 40/02; H04W 24/04; H04W 88/04

(52) U.S. Cl. CPC H04W 40/02; H04W 24/04; H04W 88/04

(57) ABSTRACT

Embodiments of the present disclosure relate to devices and methods of communication. In one aspect, a terminal device receives, from a network device, a message indicating that a first direct path between the terminal device and the network device is to be added or a second direct path between the terminal device and the network device is to be switched to the first direct path. Based on the message, the terminal device performs the addition of the first direct path or the switching towards the first direct path. In this way, once a direct path addition or switching is successful, a reconfiguration complete message may be sent to a network. Once a direct path addition or switching fails, UE may report failure information to a network or perform a reestablishment procedure.

### FIELD

Embodiments of the present disclosure generally relate to the field of communication, and in particular to devices and methods for sidelink-based communication.

### BACKGROUND

Currently, it has been proposed to explore user equipment (UE)-to-network (U2N) coverage extension for sidelink-based communication. In some scenarios where UE (also referred to as U2N remote UE herein) is out of coverage of a network device, the remote UE may access the network device via another UE (also referred to as U2N relay UE herein) in the coverage of the network device. In this case, an indirect path between the remote UE and the network device via the relay UE may be established. An indirect path is a type of U2N transmission path where data is forwarded via U2N relay UE between U2N remote UE and a network. In some scenarios where the remote UE moves into the coverage of the network device, the remote UE may directly access the network device. In this case, a direct path between the remote UE and the network device may be established. A direct path is a type of U2N transmission path where data is transmitted between UE and a network without sidelink relaying. However, communication via the indirect path and/or the direct path is still incomplete and needs to be further developed.

### SUMMARY

In general, embodiments of the present disclosure provide methods, devices and computer readable media for sidelink-based communication.

In a first aspect, there is provided a terminal device. The terminal device comprises a processor and a transceiver coupled to the processor. The processor is configured to: receive, from a network device via the transceiver, a message indicating that a first direct path between the terminal device and the network device is to be added or a second direct path between the terminal device and the network device is to be switched to the first direct path, wherein an indirect path is established between the network device and the terminal device via a further terminal device; and perform, based on the message, the addition of the first direct path or the switching towards the first direct path.

In a second aspect, there is provided a terminal device. The terminal device comprises a processor and a transceiver coupled to the processor. The processor is configured to: determine that a failure of an indirect path occurs, wherein the indirect path is established between the terminal device and a network device via a further terminal device and an direct path is established between the terminal device and the network device; and transmit information of the failure to the network device via the transceiver in the direct path.

In a third aspect, there is provided a network device. The network device comprises a processor and a transceiver coupled to the processor. The processor is configured to: transmit, to a terminal device via the transceiver, a message indicating that a first direct path between the terminal device and the network device is to be added or a second direct path between the terminal device and the network device is to be switched to the first direct path, wherein an indirect path is established between the network device and the terminal device via a further terminal device.

In a fourth aspect, there is provided a method of communication. The method comprises: receiving, at a terminal device and from a network device via the transceiver, a message indicating that a first direct path between the terminal device and the network device is to be added or a second direct path between the terminal device and the network device is to be switched to the first direct path, wherein an indirect path is established between the network device and the terminal device via a further terminal device; and performing, based on the message, the addition of the first direct path or the switching towards the first direct path.

In a fifth aspect, there is provided a method of communication. The method comprises: determining, at a terminal device, that a failure of an indirect path occurs, wherein the indirect path is established between the terminal device and a network device via a further terminal device and an direct path is established between the terminal device and the network device; and transmitting information of the failure to the network device via the transceiver in the direct path.

In a sixth aspect, there is provided a method of communication. The method comprises: transmitting, at a network device and to a terminal device via the transceiver, a message indicating that a first direct path between the terminal device and the network device is to be added or a second direct path between the terminal device and the network device is to be switched to the first direct path, wherein an indirect path is established between the network device and the terminal device via a further terminal device.

In a seventh aspect, there is provided a computer readable medium having instructions stored thereon. The instructions, when executed on at least one processor, cause the at least one processor to perform the method according to any of the fourth to sixth aspects of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings in which:

FIG. 1 illustrates an example communication environment in which some embodiments of the present disclosure can be implemented;

FIG. 2 illustrates a schematic diagram illustrating a process of communication for handling a failure of direct path addition according to embodiments of the present disclosure;

FIG. 3 illustrates a schematic diagram illustrating a process of communication for handling a failure of a direct path switching according to embodiments of the present disclosure;

FIG. 4 illustrates a schematic diagram illustrating another process of communication for handling a failure of direct path addition according to embodiments of the present disclosure;

FIG. 5 illustrates a schematic diagram illustrating a process of communication for handling a failure of an indirect path during a direct path addition or switching according to embodiments of the present disclosure;

FIG. 6 illustrates a schematic diagram illustrating a process of communication for handling a completion of a direct path addition or switching according to embodiments of the present disclosure;
FIG. 7 illustrates a schematic diagram illustrating a process of communication for handling a failure of an indirect path in multi-path scenarios according to embodiments of the present disclosure;
FIG. 8 illustrates a flowchart of an example method of communication implemented at a terminal device in accordance with some embodiments of the present disclosure;
FIG. 9 illustrates a flowchart of another example method of communication implemented at a terminal device in accordance with some embodiments of the present disclosure;
FIG. 10 illustrates a flowchart of an example method of communication implemented at a network device in accordance with some embodiments of the present disclosure; and
FIG. 11 is a simplified block diagram of a device that is suitable for implementing embodiments of the present disclosure.

Throughout the drawings, the same or similar reference numerals represent the same or similar element.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication environment” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication environment may be performed according to any suitable generation communication protocols, including but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication environment via which a terminal device can access the communication environment and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

In the context of the present disclosure, the term “remote UE” refers to a terminal device that is communicated with a network device via another terminal device in coverage of the network device. The term “relay UE” refers to a terminal device that is in coverage of a network device and via which remote UE is communication with the network device. The relay UE is connected with the remote UE via a sidelink interface such as a PC5 interface or the like. The term “remote UE” can be used interchangeably with a remote terminal device or a remote device or U2N remote UE. The term “relay UE” can be used interchangeably with a relay terminal device or a relay device or U2N relay UE.

In the context of the present disclosure, the term “first direct path” may be interchangeably used with “target direct path”. The term “second direct path” may be interchangeably used with “source direct path”. The target direct path is associated with a target cell, and the source direct path is associated with a source cell.

In some scenarios where a terminal device is configured with an indirect path, a network device may expect to add a direct path to the terminal device. In some scenarios where a terminal device is configured with an indirect path and a direct path, a network device may expect to switch the direct path to another direct path, e.g., switch a serving cell of the terminal device from a source cell to a target cell.

In view of this, embodiments of the present disclosure provide a solution of communication for the direct path addition and switching scenarios. In the solution, a network device transmits, to a terminal device, a message indicating that a first direct path between the terminal device and the network device is to be added or a second direct path between the terminal device and the network device is to be switched to the first direct path. Based on the message, the terminal device performs the addition of the first direct path or the switching towards the first direct path. In this way, the direct path addition or switching may be performed. Once a direct path addition or switching is successful, a reconfiguration complete message may be sent to a network. Once a direct path addition or switching fails, a terminal device may report failure information to a network or perform a reestablishment procedure.

In some scenarios where a terminal device is configured with an indirect path and a direct path, a failure of the indirect path may occur.

In view of this, embodiments of the present disclosure also provide a solution of communication for handling the failure. In the solution, a terminal device determines that a failure of an indirect path occurs, and transmits information of the failure to a network device in a direct path. In this way, the failure of the indirect path may be handled.

Principles and implementations of the present disclosure will be described in detail below with reference to the figures.

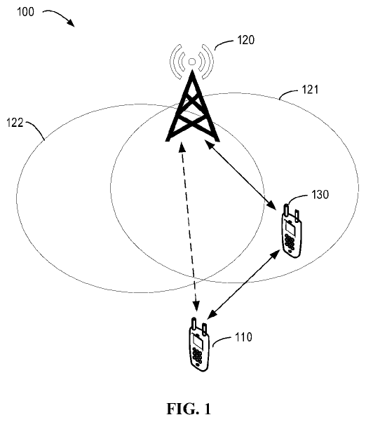

FIG. 1 illustrates a schematic diagram of a communication environment 100 in which some embodiments of the present disclosure can be implemented. As shown in FIG. 1, the communication environment 100 may include terminal devices 110 and 130 and a network device 120. The network device 120 may provide one or more serving cells (e.g., cells 121 and 122) for serving one or more terminal devices. In the example of FIG. 1, the terminal device 130 is located in the cell 121 and is served by the network device 120.

In some scenarios, the terminal device 110 may communicate with the network device 120 via the terminal device 130. In this case, the terminal device 110 serves as remote UE and the terminal device 130 serves as relay UE. An indirect path is established between the terminal device 110 and the network device 120 via the terminal device 130. For example, when the terminal device 110 is out of coverage of the network device 120 or when the terminal device 110 is located at edge of the coverage of the network device 120, the indirect path may be established.

In some scenarios, the terminal device 110 may communicate with the network device 120 directly. In this case, a direct path is established between the terminal device 110 and the network device 120. For example, when the terminal device 110 is in the coverage of the network device 120, the direct path may be established.

In some scenarios, the terminal device 110 may be configured with multi-path, i.e., both the direct path and indirect path. In this case, the terminal device 110 may communicate with the network device 120 via any of the direct path and indirect path.

As shown in FIG. 1, the terminal device 110 and the terminal device 130 may communicate with each other via a sidelink interface such as PC5 link or the like. For example, the terminal devices 110 and 130 may communicate with each other via a sidelink data channel such as a physical sidelink shared channel (PSSCH), a sidelink control channel such as a physical sidelink control channel (PSCCH) or a physical sidelink feedback channel (PSFCH), or any other existing or future sidelink channels.

As shown in FIG. 1, the network device 120 may communicate with any of the terminal devices 110 and 130 via an air interface such as Uu interface or the like. For example, the network device 120 may communicate with any of the terminal devices 110 and 13 via a wireless communication channel such as a physical downlink shared channel (PDSCH), a physical downlink control channel (PDCCH), a physical uplink shared channel (PUSCH), a physical uplink control channel (PUCCH), or any other existing or future wireless communication channels.

It is to be understood that the number of devices in FIG. 1 is given for the purpose of illustration without suggesting any limitations to the present disclosure. The communication environment 100 may include any suitable number of network devices and/or terminal devices and/or serving cells adapted for implementing embodiments of the present disclosure.

The communications in the communication environment 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some scenarios where the terminal device 110 is configured with an indirect path, the network device 120 may add a direct path to the terminal device 110. For example, the terminal device 110 may move into the cell 122 and the direct path may be established so that the terminal device 110 is served by the cell 122.

In some scenarios where the terminal device 110 is configured with both a direct path and an indirect path, the network device 120 may switch the direct path to another direct path. The direct path is associated with a source cell (e.g., the cell 122), and the other direct path is associated with a target cell (e.g., the cell 121). For example, the terminal device 110 may move into the cell 121 and the direct path may be switched from the cell 122 to the cell 121.

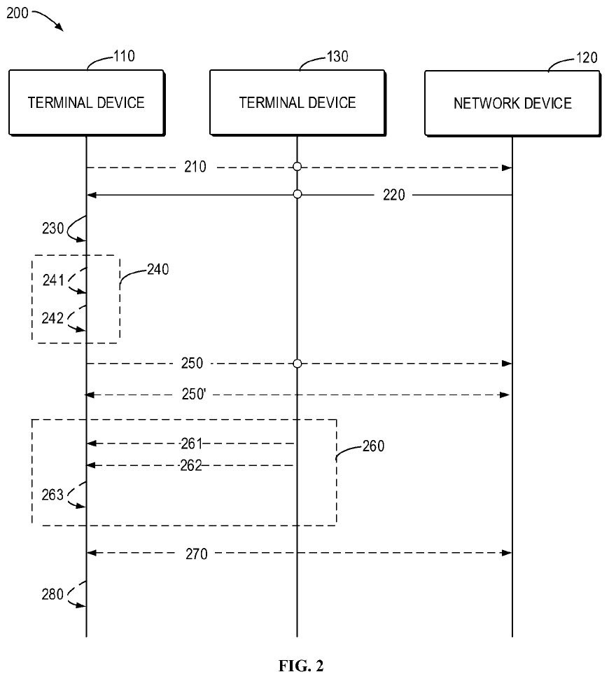

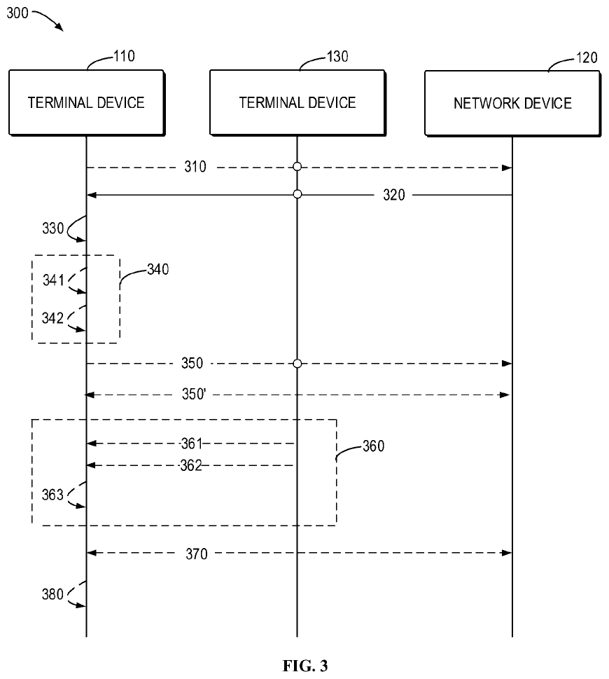

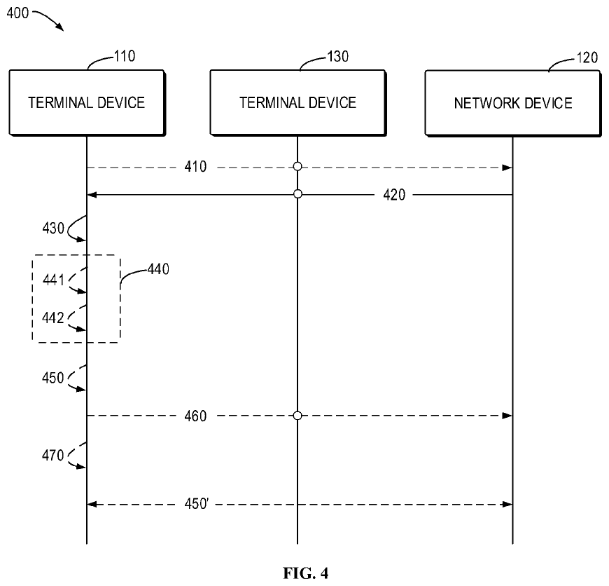

Embodiments of the present disclosure provide solutions of communication for direct path addition or switching. The solutions will be described in connection with FIGS. 2 to 6 below.

FIG. 2 illustrates a schematic diagram illustrating a process 200 of communication for handling a failure of direct path addition according to embodiments of the present disclosure. For the purpose of discussion, the process 200 will be described with reference to FIG. 1. The process 200 may involve the terminal device 110, the network device 120, and the terminal device 130 as illustrated in FIG. 1. It is to be understood that the steps and the order of the steps in FIG. 2 are merely for illustration, and not for limitation. In this example, the terminal device 110 accesses the network device 120 via an indirect path associated with the terminal device 130. The terminal device 110 may stay at a radio resource control (RRC) connected state.

As shown in FIG. 2, the terminal device 110 may report 210, to the network device 120 via the terminal device 130 (i.e., via the indirect path), results of measurements associated with neighbor cell or candidate relay based on a configuration of the measurements from the network device 120.

Based on the results of the measurements, the network device 120 may decide to add a direct path (for convenience, also referred to as a first direct path or a target direct path herein) between the terminal device 110 and the network device 120. The direct path is associated with a target cell (e.g., the cell 122). As shown in FIG. 2, the network device 120 may transmit 220, to the terminal device 110, a message indicating the addition of the direct path. In some embodiments, the message may be an RRC reconfiguration message. It is to be understood that any other suitable messages are also feasible.

In some embodiments, the message may comprise a configuration of the direct path and a configuration of the indirect path. For example, the message may comprise both target cell identity (ID) and relay UE ID. The same relay UE is involved in the indirect path.

As shown in FIG. 2, upon reception of the message such as an RRC reconfiguration message for direct path addition purpose, the terminal device 110 may perform 230 the direct path addition based on the message. Direct path addition for multi-path may be a path switch procedure in which a target configuration comprises both the direct path and the indirect path.

Continue to refer to FIG. 2, the terminal device 110 may determine 240 that the direct path addition fails. In some embodiments, the terminal device 110 may start 241 a timer upon reception of the message. For example, the timer may be T304 or any other suitable timers. During running of the timer, the terminal device 110 may continue to transmit data to the network device 120 via the terminal device 130, and/or continue to receive data from the network device 120 via the terminal device 130. If the timer expires, the terminal device 110 may determine 242 that the direct path addition fails.

Upon determination that the direct path addition fails, the terminal device 110 may report 250, to the network device 120 in the indirect path, information of the failure of the direct path addition. In some embodiments, if the indirect path is not suspended and a signaling radio bearer (SRB) such as SRB1 is configured on the indirect path, the terminal device 110 may report the information of the failure.

In some embodiments, the information of the failure of the addition may comprise a type of the failure. For example, the type of the failure may comprise direct path addition failure or the like. In some embodiments, the information of the failure of the addition may comprise a cause of the failure. For example, the cause of the failure may comprise random access problem, maximum number retransmission in radio link control (RLC) layer or the like.

As shown in FIG. 2, in some embodiments, if the indirect path is suspended or a SRB such as SRB1 is unavailable on the indirect path, the terminal device 110 may initiate 250′ a procedure of re-establishing a connection between the terminal device 110 and the network device 120, e.g., RRC reestablishment.

Continue to refer to FIG. 2, in some embodiments, upon determination that the direct path addition fails, the terminal device 110 may determine 260 that a failure of the indirect path occurs.

In some embodiments, the terminal device 110 may receive 261, from the terminal device 130, a notification message indicating a failure of a link between the network device 120 and the terminal device 130. Based on the notification message, the terminal device 110 may determine that the failure of the indirect path occurs.

In some embodiments, the terminal device 110 may receive 262, from the terminal device 130, an indication indicating a release of a link between the terminal device 110 and the terminal device 130, i.e., PC5 link release indication. Based on the indication, the terminal device 110 may determine that the failure of the indirect path occurs.

In some embodiments, the terminal device 110 may detect 263 a failure of a link between the terminal device 110 and the terminal device 130. In other words, the terminal device 110 may detect radio link failure (RLF) on PC5 link. In this case, the terminal device 110 may determine that the failure of the indirect path occurs.

Upon determination that the failure of the indirect path occurs, the terminal device 110 may initiate 270 a procedure of re-establishing a connection between the terminal device 110 and the network device 120, e.g., RRC reestablishment.

Continue to refer to FIG. 2, in some embodiments, upon determination that the direct path addition fails, the terminal device 110 may suspend 280 the target direct path.

With the process 200, a direct path addition failure may be handled. It is to be understood that operations in the process 200 may be carried out in any suitable combination or order and are not limited to the above examples.

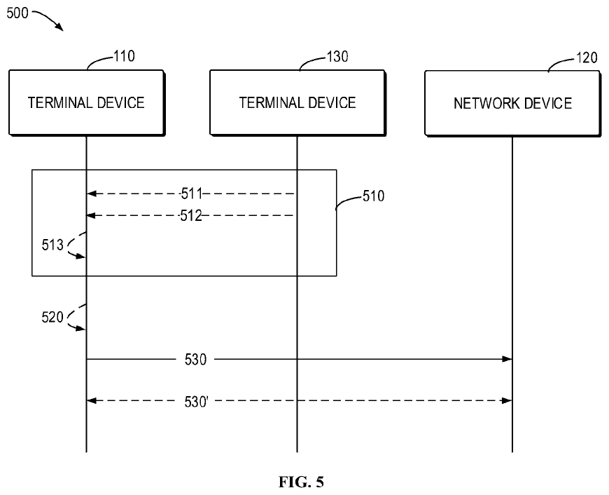

FIG. 3 illustrates a schematic diagram illustrating a process 300 of communication for handling a failure of a direct path switching according to embodiments of the present disclosure. For the purpose of discussion, the process 300 will be described with reference to FIG. 1. The process 300 may involve the terminal device 110, the network device 120, and the terminal device 130 as illustrated in FIG. 1. It is to be understood that the steps and the order of the steps in FIG. 3 are merely for illustration, and not for limitation. In this example, the terminal device 110 is configured with both an indirect path and a direct path (for convenience, also referred to as a second direct path or a source direct path herein). The source direct path is associated with the cell 121. The terminal device 110 may stay at an RRC connected state.

As shown in FIG. 3, the terminal device 110 may report 310, to the network device 120 via the terminal device 130 (i.e., via the indirect path), results of measurements associated with neighbor cell or candidate relay based on a configuration of the measurements from the network device 120.

Based on the results of the measurements, the network device 120 may decide to switch the source direct path to a target direct path. The target direct path is associated with a target cell (e.g., the cell 122). As shown in FIG. 3, the network device 120 may transmit 320, to the terminal device 110, a message indicating the switching towards the target direct path. In some embodiments, the message may be an RRC reconfiguration message. It is to be understood that any other suitable messages are also feasible.

In some embodiments, the message may comprise a configuration of the target direct path and a configuration of the indirect path. For example, the message may comprise both target cell ID and relay UE ID.

In some embodiments, the message may comprise a configuration of the target direct path and an indication indicating that the configuration of the indirect path is kept. Based on the indication, the terminal device 110 may know whether to keep the indirect path. In this way, signaling overhead may be saved.

In some embodiments where the configuration of the indirect path is unchanged, the message may only comprise a configuration of the target direct path. Based on absence of the configuration of the indirect path, the terminal device 110 may know that the indirect path is to be kept. In this way, signaling overhead may be further saved.

As shown in FIG. 3, upon reception of the message such as an RRC reconfiguration message for direct path switching purpose, the terminal device 110 may perform 330 the direct path switching based on the message.

Continue to refer to FIG. 3, the terminal device 110 may determine 340 that the direct path switching fails. In some embodiments, the terminal device 110 may start 341 a timer upon reception of the message. For example, the timer may be T304 or any other suitable timers. During running of the timer, the terminal device 110 may continue to transmit data to the network device 120 via the terminal device 130, and/or continue to receive data from the network device 120 via the terminal device 130. If the timer expires, the terminal device 110 may determine 342 that the direct path switching fails.

Upon determination that the direct path switching fails, the terminal device 110 may report 350, to the network device 120 in the indirect path, information of the failure of the direct path switching. In some embodiments, if the indirect path is not suspended and a SRB such as SRB1 is configured on the indirect path, the terminal device 110 may report the information of the failure.

In some embodiments, the information of the failure of the switching may comprise a type of the failure. For example, the type of the failure may comprise direct path switching failure or the like. In some embodiments, the information of the failure of the addition may comprise a cause of the failure. For example, the cause of the failure may comprise random access problem, maximum number retransmission in radio link control (RLC) layer or the like.

As shown in FIG. 3, in some embodiments, if the indirect path is suspended or a SRB such as SRB1 is unavailable on the indirect path, the terminal device 110 may initiate 350′ a procedure of re-establishing a connection between the terminal device 110 and the network device 120, e.g., RRC reestablishment.

Continue to refer to FIG. 3, in some embodiments, upon determination that the direct path switching fails, the terminal device 110 may determine 360 that a failure of the indirect path occurs.

In some embodiments, the terminal device 110 may receive 361, from the terminal device 130, a notification message indicating a failure of a link between the network device 120 and the terminal device 130. Based on the notification message, the terminal device 110 may determine that the failure of the indirect path occurs.

In some embodiments, the terminal device 110 may receive 362, from the terminal device 130, an indication indicating a release of a link between the terminal device 110 and the terminal device 130, i.e., PC5 link release indication. Based on the indication, the terminal device 110 may determine that the failure of the indirect path occurs.

In some embodiments, the terminal device 110 may detect 363 a failure of a link between the terminal device 110 and the terminal device 130. In other words, the terminal device 110 may detect RLF on PC5 link. In this case, the terminal device 110 may determine that the failure of the indirect path occurs.

Upon determination that the failure of the indirect path occurs, the terminal device 110 may initiate 370 a procedure of re-establishing a connection between the terminal device 110 and the network device 120, e.g., RRC reestablishment.

Continue to refer to FIG. 3, in some embodiments, upon determination that the direct path switching fails, the terminal device 110 may suspend 380 the target direct path.

With the process 300, a direct path switching failure may be handled. It is to be understood that operations in the process 300 may be carried out in any suitable combination or order and are not limited to the above examples.

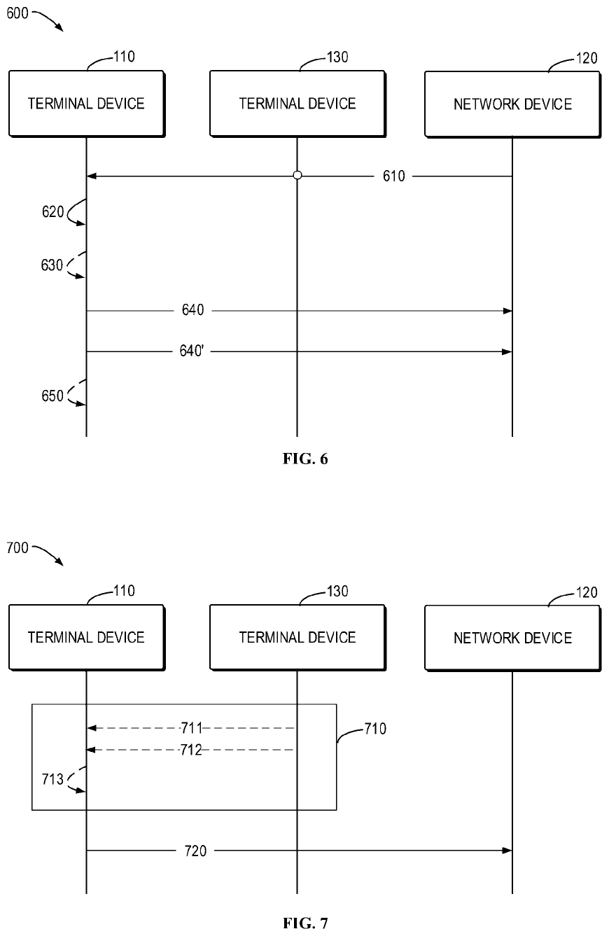

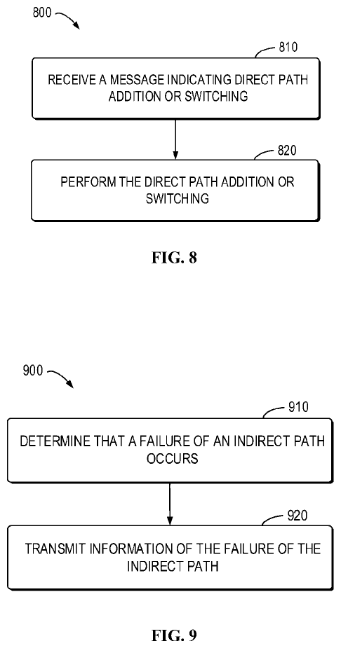

FIG. 4 illustrates a schematic diagram illustrating another process 400 of communication for handling a failure of direct path addition according to embodiments of the present disclosure. For the purpose of discussion, the process 400 will be described with reference to FIG. 1. The process 400 may involve the terminal device 110, the network device 120, and the terminal device 130 as illustrated in FIG. 1. It is to be understood that the steps and the order of the steps in FIG. 4 are merely for illustration, and not for limitation. In this example, the terminal device 110 accesses the network device 120 via an indirect path associated with the terminal device 130. The terminal device 110 may stay at an RRC connected state.

As shown in FIG. 4, the terminal device 110 may report 410, to the network device 120 via the terminal device 130 (i.e., via the indirect path), results of measurements associated with neighbor cell or candidate relay based on a configuration of the measurements from the network device 120.

Based on the results of the measurements, the network device 120 may decide to add a target direct path between the terminal device 110 and the network device 120. The target direct path is associated with a target cell (e.g., the cell 122). As shown in FIG. 4, the network device 120 may transmit 420, to the terminal device 110, a message indicating the addition of the target direct path. In some embodiments, the message may be an RRC reconfiguration message. It is to be understood that any other suitable messages are also feasible.

In some embodiments, the message may comprise a configuration of the target direct path and a configuration of the indirect path. For example, the message may comprise both target cell ID and relay UE ID. The same relay UE is involved in the indirect path.

As shown in FIG. 4, upon reception of the message such as an RRC reconfiguration message for direct path addition purpose, the terminal device 110 may perform 430 the direct path addition based on the message.

Continue to refer to FIG. 4, the terminal device 110 may determine 440 that the direct path addition fails. In some embodiments, the terminal device 110 may start 441 a timer upon reception of the message. For example, the timer may be T304 or any other suitable timers. During running of the timer, the terminal device 110 may continue to transmit data to the network device 120 via the terminal device 130, and/or continue to receive data from the network device 120 via the terminal device 130. If the timer expires, the terminal device 110 may determine 442 that the direct path addition fails.

Upon determination that the direct path addition fails, the terminal device 110 may revert back 450 to a configuration of the indirect path. In some embodiments, the terminal device 110 may revert back to a configuration of the indirect path prior to reception of the message indicating the target direct path addition.

Continue to refer to FIG. 4, the terminal device 110 may report 460, to the network device 120 in the indirect path, information of the failure of the direct path addition. In some embodiments, the information of the failure of the addition may comprise a type of the failure. For example, the type of the failure may comprise direct path addition failure or the like. In some embodiments, the information of the failure of the addition may comprise a cause of the failure. For example, the cause of the failure may comprise random access problem, maximum number retransmission in RLC layer or the like.

As shown in FIG. 4, the terminal device 110 may release 470 the configuration of the target direct path comprised in the message.

Alternatively, upon determination that the direct path addition fails, the terminal device 110 may directly initiate 450′ a procedure of re-establishing a connection between the terminal device 110 and the network device 120, e.g., RRC reestablishment.

With the process 400, a direct path addition failure may also be handled. It is to be understood that operations in the process 400 may be carried out in any suitable combination or order and are not limited to the above examples.

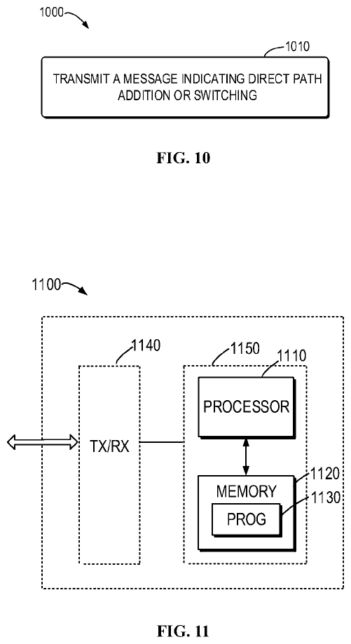

FIG. 5 illustrates a schematic diagram illustrating a process 500 of communication for handling a failure of an indirect path during a direct path addition or switching according to embodiments of the present disclosure. For the purpose of discussion, the process 500 will be described with reference to FIG. 1. The process 500 may involve the terminal device 110, the network device 120, and the terminal device 130 as illustrated in FIG. 1. It is to be understood that the steps and the order of the steps in FIG. 5 are merely for illustration, and not for limitation. It is assumed that the terminal device 110 is performing a direct path addition or switching for a target direct path.

As shown in FIG. 5, the terminal device 110 may determine 510 that a failure of the indirect path occurs during the direct path addition or switching. In some embodiments, the terminal device 110 may receive 511, from the terminal device 130, a notification message indicating a failure of a link between the network device 120 and the terminal device 130. Based on the notification message, the terminal device 110 may determine that the failure of the indirect path occurs.

In some embodiments, the terminal device 110 may receive 512, from the terminal device 130, an indication indicating a release of a link between the terminal device 110 and the terminal device 130, i.e., PC5 link release indication. Based on the indication, the terminal device 110 may determine that the failure of the indirect path occurs.

In some embodiments, the terminal device 110 may detect 513 a failure of a link between the terminal device 110 and the terminal device 130. In other words, the terminal device 110 may detect RLF on PC5 link. In this case, the terminal device 110 may determine that the failure of the indirect path occurs.

As shown in FIG. 5, upon determination that the failure of the indirect path occurs during the direct path addition or switching, the terminal device 110 may suspend 520 the indirect path. Upon determination that the target direct path is successfully added, the terminal device 110 may report 530, to the network device 120 in the target direct path, information of the failure of the indirect path.

In some embodiments, the information of the failure of the indirect path may comprise a type of the failure. For example, the type of the failure may comprise indirect path failure or the like. In some embodiments, the information of the failure of the indirect path may comprise a cause of the failure. For example, the cause of the failure may comprise reception of a notification message, reception of PC5 link release indication, or RLF detection on PC5 link, and so on.

Alternatively, as shown in FIG. 5, upon determination that the failure of the indirect path occurs during the direct path addition or switching, the terminal device 110 may directly initiate 530′ a procedure of re-establishing a connection between the terminal device 110 and the network device 120.

With the process 500, a failure of an indirect path during direct path addition or switching may be handled. It is to be understood that operations in the process 500 may be carried out in any suitable combination or order and are not limited to the above examples.

FIG. 6 illustrates a schematic diagram illustrating a process 600 of communication for handling a completion of a direct path addition or switching according to embodiments of the present disclosure. For the purpose of discussion, the process 600 will be described with reference to FIG. 1. The process 600 may involve the terminal device 110, the network device 120, and the terminal device 130 as illustrated in FIG. 1. It is to be understood that the steps and the order of the steps in FIG. 6 are merely for illustration, and not for limitation.

As shown in FIG. 6, the network device 120 may transmit 610, to the terminal device 110, a message indicating a direct path addition or switching for a target direct path. The target direct path is associated with a target cell. In some embodiments, the message may be an RRC reconfiguration message. It is to be understood that any other suitable messages are also feasible. Other details of the message are similar to that described in connection with FIGS. 2 to 5, and thus are omitted here for concise.

As shown in FIG. 6, upon reception of the message, the terminal device 110 may perform 620 the direct path addition or switching based on the message. In some embodiments, the terminal device 110 may start 630 a timer upon reception of the message. In some embodiments, the timer may be T304 or any other suitable timers. During running of the timer, the terminal device 110 may continue to transmit data to the network device 120 via the terminal device 130, and/or continue to receive data from the network device 120 via the terminal device 130.

As shown in FIG. 6, when the direct path addition or switching is successfully completed, i.e., when the terminal device 110 successfully accesses the target cell, the terminal device 110 may transmit 640, to the network device 120, a further message indicating the completion of the direct path addition or switching in the target direct path. In other words, regardless of whether the indirect path is available or not, the terminal device 110 may transmit the further message via the target direct path.

In some alternative embodiments, if the indirect path is available, the terminal device 110 may transmit 640′ the further message to the network device 120 in one of the target direct path and the indirect path. In other words, the terminal device 110 may select any one of the target direct path and the indirect path for transmission of the further message.

In some embodiments, when the direct path addition or switching is successfully completed, the terminal device 110 may stop 650 the timer.

With the process 600, a completion of a direct path addition or switching may be indicated to a network. It is to be understood that operations in the process 600 may be carried out in any suitable combination or order and are not limited to the above examples.

So far, solutions for direct path addition or switching are described with reference to the processes 200 to 600. It is to be understood that the processes 200 to 600 may be performed separately or in any suitable combination.

Embodiments of the present disclosure also provide a solution of communication for handling a failure of an indirect path in multi-path scenarios. The solution will be described in connection with FIG. 7 below.

FIG. 7 illustrates a schematic diagram illustrating a process 700 of communication for handling a failure of an indirect path in multi-path scenarios according to embodiments of the present disclosure. For the purpose of discussion, the process 700 will be described with reference to FIG. 1. The process 700 may involve the terminal device 110, the network device 120, and the terminal device 130 as illustrated in FIG. 1. It is to be understood that the steps and the order of the steps in FIG. 7 are merely for illustration, and not for limitation.

In this example, the terminal device 110 is configured with a multi-path configuration. In other words, an indirect path is established between the terminal device 110 and the network device 120 via a further terminal device and a direct path is established between the terminal device 110 and the network device 120. The terminal device 110 may access the network device 120 via any of an indirect path associated with the terminal device 130 and a direct path.

As shown in FIG. 7, the terminal device 110 may determine 710 that a failure of the indirect path occurs. In some embodiments, the terminal device 110 may receive 711, from the terminal device 130, a notification message indicating a failure of a link between the network device 120 and the terminal device 130. Based on the notification message, the terminal device 110 may determine that the failure of the indirect path occurs.

In some embodiments, the terminal device 110 may receive 712, from the terminal device 130, an indication indicating a release of a link between the terminal device 110 and the terminal device 130, i.e., PC5 link release indication. Based on the indication, the terminal device 110 may determine that the failure of the indirect path occurs.

In some embodiments, the terminal device 110 may detect 713 a failure of a link between the terminal device 110 and the terminal device 130. In other words, the terminal device 110 may detect RLF on PC5 link. In this case, the terminal device 110 may determine that the failure of the indirect path occurs.

As shown in FIG. 7, upon determination that the failure of the indirect path occurs, the terminal device 110 may transmit 720, in the direct path, information of the failure of the indirect path to the network device 120.

In some embodiments, the information of the failure of the indirect path may comprise a type of the failure. For example, the type of the failure may comprise indirect path failure or the like. In some embodiments, the information of the failure of the indirect path may comprise a cause of the failure. For example, the cause of the failure may comprise reception of a notification message, reception of PC5 link release indication, or RLF detection on PC5 link, and so on.

With the process 700, a failure of an indirect path may be reported to a network via a direct path. It is to be understood that operations in the process 700 may be carried out in any suitable combination or order and are not limited to the above examples.

Corresponding to the above processes, embodiments of the present disclosure provide methods of communication implemented at a terminal device. These methods will be described below with reference to FIGS. 8 to 10.

FIG. 8 illustrates a flowchart of an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 receives, from the network device 120, a message indicating that a first direct path between the terminal device 110 and the network device 120 is to be added or a second direct path between the terminal device 110 and the network device 120 is to be switched to the first direct path. An indirect path is established between the network device 120 and the terminal device 110 via a further terminal device (e.g., the terminal device 130).

In some embodiments, the second direct path is associated with a source cell, and the first direct path is associated with a target cell.

In some embodiments, the message may comprise a configuration of the first direct path and a configuration of the indirect path. In some embodiments, the message may comprise the configuration of the first direct path and an indication indicating that the configuration of the indirect path is kept.

At block 820, the terminal device 110 performs, based on the message, the addition of the first direct path or the switching towards the first direct path.

In some embodiments, the terminal device 110 may determine that the addition or switching fails. In some embodiments, if the message is received, the terminal device 110 may start a timer. If the timer expires, the terminal device 110 may determine that the addition or switching fails.

In some embodiments where the addition or switching fails, the terminal device 110 may report, to the network device 120 in the indirect path, information of the failure of the addition or switching. In some embodiments, the information of the failure of the addition or switching may comprise at least one of the following: a type of the failure, or a cause of the failure. In some embodiments, if the indirect path is unsuspended and a SRB is configured on the indirect path, the terminal device 110 may report the information of the failure.

In some embodiments where the addition or switching fails, if the indirect path is suspended or a SRB is unavailable on the indirect path, the terminal device 110 may initiate a procedure of re-establishing a connection between the terminal device 110 and the network device 120.

In some embodiments where the addition or switching fails, if a failure of the indirect path occurs, the terminal device 110 may initiate a procedure of re-establishing a connection between the terminal device 110 and the network device 120.

In some embodiments where the addition or switching fails, the terminal device 110 may suspend the first direct path.

In some embodiments where the addition or switching fails, the terminal device 110 may revert back to a configuration of the indirect path. In some embodiments, the terminal device 110 may release a configuration of the first direct path comprised in the message.

In some embodiments where the addition or switching fails, the terminal device 110 may initiate a procedure of re-establishing a connection between the terminal device 110 and the network device 120.

In some embodiments, the terminal device 110 may determine that the failure of the indirect path occurs. In some embodiments, the terminal device 110 may receive, from the terminal device 130, a notification message indicating a failure of a link between the network device 120 and the terminal device 130. Based on the notification message, the terminal device 110 may determine that the failure of the indirect path occurs. In some embodiments, the terminal device 110 may receive, from the terminal device 130, an indication indicating a release of a link between the terminal device 110 and the terminal device 130. Based on the indication, the terminal device 110 may determine that the failure of the indirect path occurs. In some embodiments, the terminal device 110 may detect a failure of a link between the terminal device 110 and the terminal device 130. Based on the failure detection, the terminal device 110 may determine that the failure of the indirect path occurs.

In some embodiments, if the failure of the indirect path occurs during the addition or switching, the terminal device 110 may suspend the indirect path. In some embodiments, if the first direct path is successfully added or switched, the terminal device 110 may report, to the network device 120 in the first direct path, information of the failure of the indirect path.

In some embodiments, if the failure of the indirect path occurs during the addition or switching, the terminal device 110 may initiate a procedure of re-establishing a connection between the terminal device 110 and the network device 120.

In some embodiments, if the addition or switching is completed, the terminal device 110 may transmit, to the network device 120 in the first direct path, a further message indicating the completion of the addition or switching. In some embodiments, if the addition or switching is completed and that the indirect path is available, the terminal device 110 may transmit the further message to the network device 120 in one of the first direct path and the indirect path.

With the method 800, a direct path addition or switching may be carried out.

FIG. 9 illustrates a flowchart of another example method 900 of communication implemented at a terminal device in accordance with some embodiments of the present disclosure. For example, the method 900 may be performed at the terminal device 110 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the terminal device 110 determines that a failure of an indirect path occurs. The indirect path is established between the terminal device 110 and the network device 120 via a further terminal device (e.g., the terminal device 130) and a direct path is established between the terminal device 110 and the network device 120.

In some embodiments, the terminal device 110 may receive, from the terminal device 130, a notification message indicating a failure of a link between the network device 120 and the terminal device 130. Based on the notification message, the terminal device 110 may determine that the failure of the indirect path occurs.

In some embodiments, the terminal device 110 may receive, from the terminal device 130, an indication indicating a release of a link between the terminal device 110 and the terminal device 130. Based on the indication, the terminal device 110 may determine that the failure of the indirect path occurs.

In some embodiments, the terminal device 110 may detect a failure of a link between the terminal device 110 and the terminal device 130. Based on the failure detection, the terminal device 110 may determine that the failure of the indirect path occurs.

At block 920, the terminal device 110 transmits information of the failure to the network device 120 in the direct path.

With the method 900, a failure of indirect path may be reported to a network via a direct path.

FIG. 10 illustrates a flowchart of an example method 1000 of communication implemented at a network device in accordance with some embodiments of the present disclosure. For example, the method 1000 may be performed at the network device 120 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the network device 120 transmits, to the terminal device 110, a message indicating that a first direct path between the terminal device 110 and the network device 120 is to be added or a second direct path between the terminal device 110 and the network device 120 is to be switched to the first direct path. An indirect path is established between the network device 120 and the terminal device 110 via a further terminal device (e.g., the terminal device 130).

In some embodiments, the second direct path is associated with a source cell, and the first direct path is associated with a target cell.

In some embodiments, the message may comprise a configuration of the first direct path and a configuration of the indirect path. In some embodiments, the message may comprise the configuration of the first direct path and an indication indicating that the configuration of the indirect path is kept.

In some embodiments, the network device 120 may receive, from the terminal device 110 in the indirect path, information of a failure of the addition or switching. In some embodiments, the information of the failure of the addition or switching may comprise at least one of the following: a type of the failure, or a cause of the failure.

In some embodiments, the network device 120 may receive, from the terminal device 110 in the first direct path, information of a failure of the indirect path during the addition or switching.

In some embodiments, the network device 120 may receive, from the terminal device 110 in the first direct path, a further message indicating the completion of the addition or switching. In some embodiments, the network device 120 may receive the further message from the terminal device 110 in one of the first direct path and the indirect path.

With the method 1000, a direct path addition or switching may be facilitated.

It is to be understood that operations of the methods 800 to 1000 correspond to that described in connection with FIGS. 2 to 7, and thus other details are not repeated here for concise.

FIG. 11 is a simplified block diagram of a device 1100 that is suitable for implementing embodiments of the present disclosure. The device 1100 can be considered as a further example implementation of the terminal device 110 or the network device 120 or the terminal device 130 as shown in FIG. 1. Accordingly, the device 1100 can be implemented at or as at least a part of the terminal device 110 or the network device 120 or the terminal device 130.

As shown, the device 1100 includes a processor 1110, a memory 1120 coupled to the processor 1110, a suitable transmitter (TX) and receiver (RX) (e.g., a transceiver) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In summary, embodiments of the present disclosure provide the following solutions.

In one solution, a terminal device comprising: a processor; and a transceiver coupled to the processor, wherein the processor is configured to: receive, from a network device via the transceiver, a message indicating that a first direct path between the terminal device and the network device is to be added or a second direct path between the terminal device and the network device is to be switched to the first direct path, wherein an indirect path is established between the network device and the terminal device via a further terminal device; and perform, based on the message, the addition of the first direct path or the switching towards the first direct path.

In some embodiments, the second direct path is associated with a source cell, and the first direct path is associated with a target cell.

In some embodiments, the processor is further configured to: determine that the addition or switching fails; and report, to the network device via the transceiver in the indirect path, information of the failure of the addition or switching.

In some embodiments, the information of the failure of the addition or switching comprises at least one of the following: a type of the failure, or a cause of the failure.

In some embodiments, the processor is configured to report the information of the failure by: in accordance with a determination that the indirect path is unsuspended and a signaling radio bearer is configured on the indirect path, reporting the information of the failure.

In some embodiments, the processor is further configured to: determine that the addition or switching fails; and in accordance with a determination that the indirect path is suspended or a signaling radio bearer is unavailable on the indirect path, initiate a procedure of re-establishing a connection between the terminal device and the network device.

In some embodiments, the processor is further configured to: determine that the addition or switching fails; and in accordance with a determination that a failure of the indirect path occurs, initiate a procedure of re-establishing a connection between the terminal device and the network device.

In some embodiments, the processor is further configured to: determine that the addition or switching fails; and suspend the first direct path.

In some embodiments, the processor is further configured to: determine that the addition or switching fails; and revert back to a configuration of the indirect path.

In some embodiments, the processor is further configured to: release a configuration of the first direct path comprised in the message.

In some embodiments, the processor is further configured to: determine that the addition or switching fails; and initiate a procedure of re-establishing a connection between the terminal device and the network device.

In some embodiments, the processor is configured to determine that the addition or switching fails by: in accordance with a determination that the message is received, starting a timer; and in accordance with a determination that the timer expires, determine that the addition or switching fails.

In some embodiments, the processor is further configured to: in accordance with a determination that a failure of the indirect path occurs during the addition or switching, suspend the indirect path; and in accordance with a determination that the first direct path is successfully added or switched, report, to the network device via the transceiver in the first direct path, information of the failure of the indirect path.

In some embodiments, the processor is further configured to: in accordance with a determination that a failure of the indirect path occurs during the addition or switching, initiate a procedure of re-establishing a connection between the terminal device and the network device.

In some embodiments, the processor is further configured to determine that the failure of the indirect path occurs by at least one of the following: receiving, from the further terminal device via the transceiver, a notification message indicating a failure of a link between the network device and the further terminal device; receiving, from the further terminal device via the transceiver, an indication indicating a release of a link between the terminal device and the further terminal device; or detecting a failure of a link between the terminal device and the further terminal device.

In some embodiments, the message comprises a configuration of the first direct path and a configuration of the indirect path. In some embodiments, the message comprises the configuration of the first direct path and an indication indicating that the configuration of the indirect path is kept.

In some embodiments, the processor is further configured to: in accordance with a determination that the addition or switching is completed, transmit, to the network device via the transceiver in the first direct path, a further message indicating the completion of the addition or switching; or in accordance with a determination that the addition or switching is completed and that the indirect path is available, transmit the further message to the network device via the transceiver in one of the first direct path and the indirect path.

In another solution, a terminal device comprises: a processor; and a transceiver coupled to the processor, wherein the processor is configured to: determine that a failure of an indirect path occurs, wherein the indirect path is established between the terminal device and a network device via a further terminal device and a direct path is established between the terminal device and the network device; and transmit information of the failure to the network device via the transceiver in the direct path.

In some embodiments, the processor is configured to determine that the failure of the indirect path occurs by at least one of the following: receiving, from the further terminal device via the transceiver, a notification message indicating a failure of a link between the network device and the further terminal device; receiving, from the further terminal device via the transceiver, an indication indicating a release of a second link between the terminal device and the further terminal device; or detecting a failure of a link between the terminal device and the further terminal device.

In another solution, a network device comprises: a processor; and a transceiver coupled to the processor, wherein the processor is configured to: transmit, to a terminal device via the transceiver, a message indicating that a first direct path between the terminal device and the network device is to be added or a second direct path between the terminal device and the network device is to be switched to the first direct path, wherein an indirect path is established between the network device and the terminal device via a further terminal device.

In some embodiments, the second direct path is associated with a source cell, and the first direct path is associated with a target cell.

In some embodiments, the processor is further configured to: receive, from the terminal device via the transceiver in the indirect path, information of a failure of the addition or switching.

In some embodiments, the information of the failure of the addition or switching comprises at least one of the following: a type of the failure, or a cause of the failure.

In some embodiments, the processor is further configured to: receive, from the terminal device via the transceiver in the first direct path, information of a failure of the indirect path during the addition or switching.

In some embodiments, the message comprises a configuration of the first direct path and a configuration of the indirect path. In some embodiments, the message comprises the configuration of the first direct path and an indication indicating that the configuration of the indirect path is kept.

In some embodiments, the processor is further configured to: receive, from the terminal device via the transceiver in the first direct path, a further message indicating the completion of the addition or switching; or receive the further message from the terminal device via the transceiver in one of the first direct path and the indirect path.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one memory; and
at least one processor coupled with the at least one memory and configured to cause the terminal device to:
receive, from a network device, a message indicating that a first direct path between the terminal device and the network device is to be added or a second direct path between the terminal device and the network device is to be switched to the first direct path, wherein an indirect path is established between the network device and the terminal device via a second terminal device; and
perform, based on the message, addition of the first direct path or switching towards the first direct path.

2. The terminal device of claim 1, wherein the second direct path is associated with a source cell, and the first direct path is associated with a target cell.

3. The terminal device of claim 1, wherein the at least one processor is configured to cause the terminal device to:
determine that the addition or switching fails; and
report, to the network device in the indirect path, information of failure of the addition or switching.

4. The terminal device of claim 3, wherein the information of the failure of the addition or switching comprises at least one of the following:
a type of the failure, or
cause of the failure.

5. The terminal device of claim 3, wherein the at least one processor is configured to cause the terminal device to report the information of the failure in response to a determination that the indirect path is unsuspended and a signaling radio bearer is configured on the indirect path.

6. The terminal device of claim 1, wherein the at least one processor is configured to cause the terminal device to:
determine that the addition or switching fails; and
in response to a determination that the indirect path is suspended or a signaling radio bearer is unavailable on the indirect path, initiate a procedure of re-establishing a connection between the terminal device and the network device.

7. The terminal device of claim 1, wherein the at least one processor is configured to cause the terminal device to:
determine that the addition or switching fails; and
in response to a determination that a failure of the indirect path occurs, initiate a procedure of re-establishing a connection between the terminal device and the network device.

8. The terminal device of claim 1, wherein the at least one processor is configured to cause the terminal device to:
determine that the addition or switching fails; and
suspend the first direct path.

9. The terminal device of claim 3, wherein the at least one processor is configured to cause the terminal device to:
in response to a determination that the message is received, start a timer; and
in response to a determination that the timer expires, determine that the addition or switching fails.

10. The terminal device of claim 1, wherein the at least one processor is configured to cause the terminal device to:
in response to a determination that a failure of the indirect path occurs during the addition or switching, suspend the indirect path; and
in response to a determination that the first direct path is successfully added or switched, report, to the network device in the first direct path, information of the failure of the indirect path.

11. The terminal device of claim 7, wherein the at least one processor is configured to cause the terminal device to determine that the failure of the indirect path occurs in response to at least one of:
receiving, from the second terminal device, a notification message indicating a failure of a link between the network device and the second terminal device;
receiving, from the second terminal device, an indication indicating a release of a link between the terminal device and the second terminal device; or
detecting a failure of a link between the terminal device and the second terminal device.

12. The terminal device of claim 1, wherein the at least one processor is configured to cause the terminal device to:
in response to a determination that the addition or switching is completed, transmit, to the network device in the first direct path, a second message indicating completion of the addition or switching; or
in response to a determination that the addition or switching is completed and that the indirect path is available, transmit the second message to the network device in one of the first direct path and the indirect path.

13. A terminal device comprising:
at least one memory; and
at least one processor coupled with the at least one memory and configured to cause the terminal device to:
determine that a failure of an indirect path occurs, wherein the indirect path is established between the terminal device and a network device via a second terminal device and a direct path is established between the terminal device and the network device; and
transmit information of the failure to the network device in the direct path.

14. The terminal device of claim 13, wherein the at least one processor is configured to cause the terminal device to determine that the failure of the indirect path occurs by at least one of the following:
receiving, from the second terminal device, a notification message indicating a failure of a link between the network device and the second terminal device;
receiving from the second terminal device, an indication indicating a release of a second link between the terminal device and the second terminal device; or
detecting a failure of a link between the terminal device and the second terminal device.

15. A network device comprising:
at least one memory; and
at least one processor coupled with the at least one memory and configured to cause the network device to:
transmit, to a terminal device, a message indicating that a first direct path between the terminal device and the network device is to be added or a second direct path between the terminal device and the network device is to be switched to the first direct path, wherein an indirect path is established between the network device and the terminal device via a second terminal device.

16. A method performed by a terminal device, comprising:
receiving, from a network device, a message indicating that a first direct path between the terminal device and the network device is to be added or a second direct path between the terminal device and the network device is to be switched to the first direct path, wherein an indirect path is established between the network device and the terminal device via a second terminal device; and
performing, based on the message, addition of the first direct path or the switching towards the first direct path.

17. The method of claim 16, wherein the second direct path is associated with a source cell, and the first direct path is associated with a target cell.

18. The method of claim 16, further comprising:
determining that the addition or switching fails; and
reporting, to the network device in the indirect path, information of failure of the addition or switching.

19. The method of claim 18, wherein the information of the failure of the addition or switching comprises at least one of the following:
a type of the failure, or
a cause of the failure.

20. The method of claim 18, further comprising reporting the information of the failure in response to a determination that the indirect path is unsuspended and a signaling radio bearer is configured on the indirect path.
